(19) United States
(12) Patent Application Publication
(10) Pub. No.: US 2006/0249433 A1
(43) Pub. Date: Nov. 9, 2006

(54) Machine for separating metal from dirt and other material

(76) Inventor: Gerald Amyx, Hamilton, OH (US)

Correspondence Address: GERALD AMYX, 5300 DUNWOODY ROAD, HAMILTON, OH, 45013, US

(21) Appl. No.: 11/314,026

(22) Filed: Dec. 22, 2005

Related U.S. Application Data
(60) Provisional application No. 60/639,267, filed on Dec. 27, 2004.

(51) Int. Cl. B07B 1/24

(52) U.S. Cl. 209/293

(57) ABSTRACT

A method and apparatus for separating metal from dirt and other material based on heating the metal and dirt, cooling the metal to freeze the same and scraping the metal for collection and reuse.

### RELATED APPLICATION

The present invention is a continuation of Provisional Application Ser. No. 60/639,267 filed on Dec. 28, 2004.

### FIELD OF THE INVENTION

The primary function, broadly speaking, is to separate metal from dirt, refuse and the like in a simple fashion.

The present invention is directed to this separation and includes an elongated cylindrical double-walled housing of suitable size for receiving the metal and dirt/refuse mix, spaced rollers on the bottom thereof to rotate the housing, conveyor means disposed on the front and rear thereof for receiving and removing the metal and dirt/refuse mix, a divider disc mounted between the center of the housing with the lower half being covered with chains and barbs to receive and pulverize the metal and dirt/refuse which is conveyed into the upper half, heating means in the double-walled cylinder extending to the disc, and cooling means in the double-walled cylinder extending from the disc to the end of the cylinder wherein the metal and dirt/refuse are heated in the front part of the cylinder as it rotates and dispenses and passes into the open disc where the metal is frozen in the second part, whereat the dirt/refuse drops to the bottom and collected, with the frozen metal scraped from the cylinder walls and collected. The metal is then collected for further use, and the dirt discarded.

### BRIEF DESCRIPTION OF THE DRAWINGS

FIG. 1 shows a rotary housing supporting a mixture of metal, dirt, refuse and the like and means for separating the same;

FIG. 1A shows some of the details of the housing;

FIG. 2 shows conveyor feed means entering the housing;

FIG. 3 shows other details of the housing and collection means for the metal and dirt/refuse with vacuum means to facilitate the separation thereof,

FIGS. 4 and 5 show other incidental details of the housing.

### DETAILED DESCRIPTION OF THE INVENTION

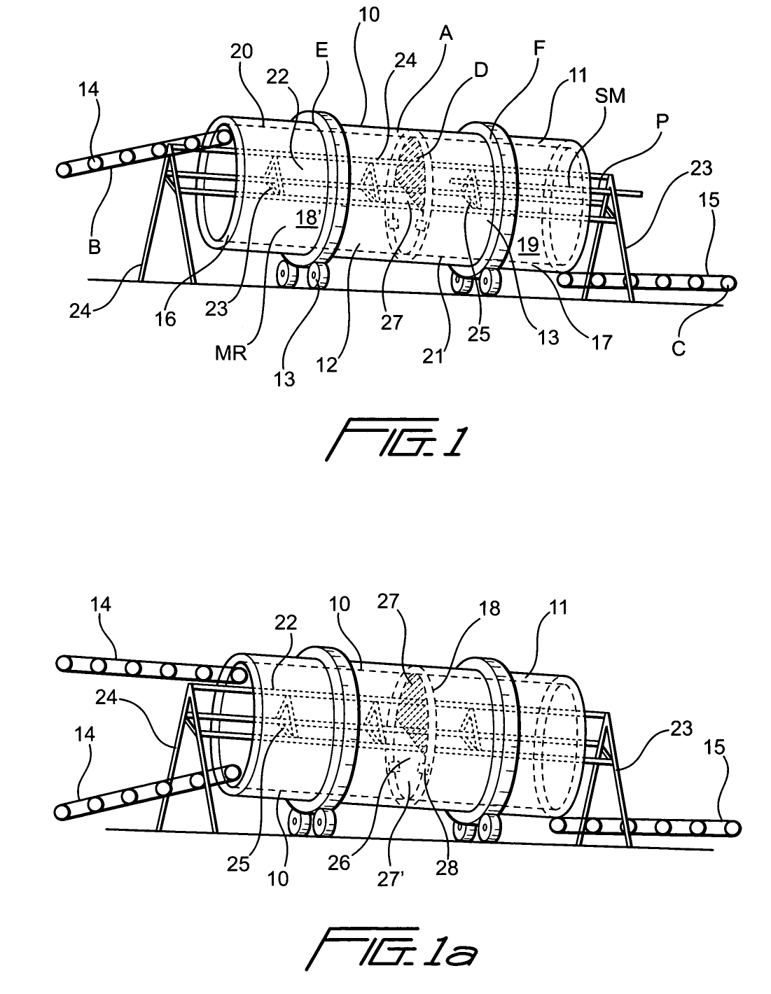

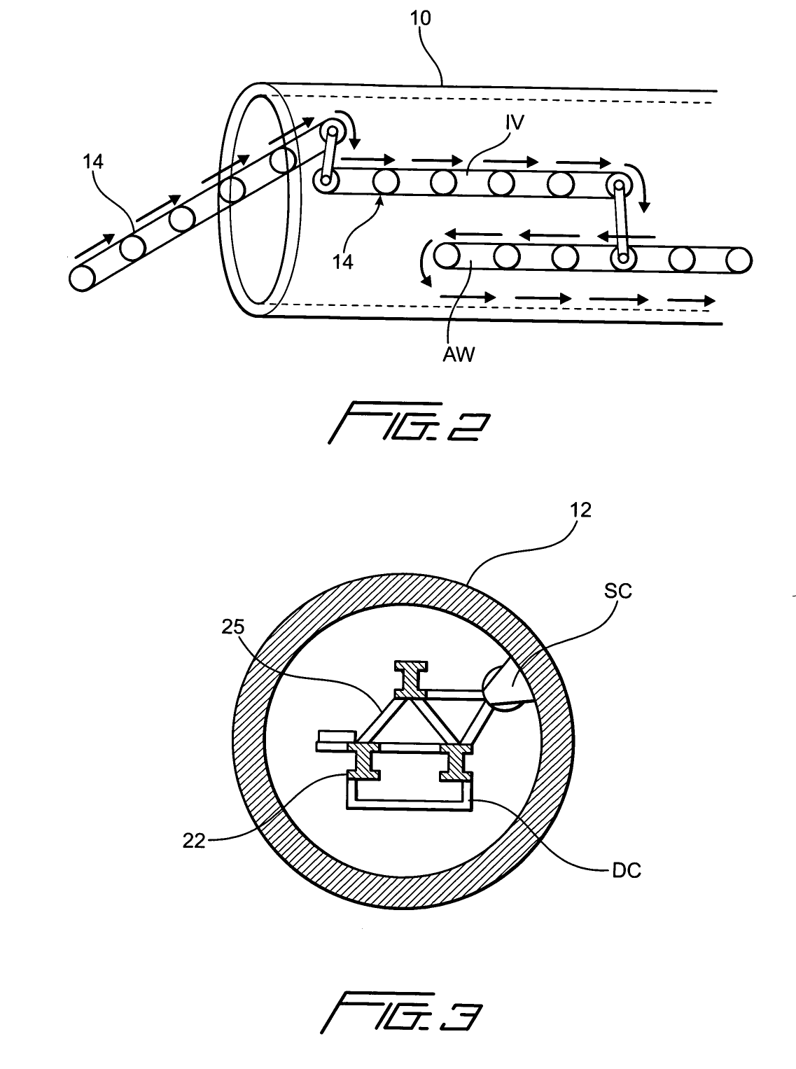

With reference to FIG. 1, the means for collecting the metal from dirt/refuse and the like including a rotary double-walled cylindrical housing of suitable length A, conveyors B for introducing the metal and dirt/refuse into the front end thereof, and a conveyor C for disposing the separated metal and dirt/refuse at the rear end thereof, a disc D dividing the cylinder into different sections E, F, one section E having heat conveyed into the double-walled cylinder leading to the disc D, and section F having coolant conveyed therein, and support means SM within the cylinder and extending the length thereof to assist in holding the scraper SC and piping P for aiding in collecting the metal and dust.

With continuing reference to FIG. 1, the mixed metal, dirt/refuse MR will be introduced into the double-walled cylinder 10, 11 and housing 12 of suitable length L, being rotated by rollers 13, 13 at the bottom of the housing, an inlet conveyor 14 and an outlet conveyor 15 disposed at the front 16 and rear 17 for conveying the material MR into and out of the housing 12, a disc 18 dividing the housing 12 into separate parts 18, 19 with heat 20 conducted into the double-walled cylinder 10 of part 18 and coolant 21 conducted into the double-walled cylinder interior 19 with the disc 18 serving to separate the metal, dirt/refuse MR as it is processed through the housing 12.

Referring again to FIG. 1 and to FIG. 1A, the disc 18 fills the interior housing with the bottom half 26 covering the lower half of disc 18 and the top half 27 being open. The bottom half 26 has chains 27 (FIG. 1) and tangs 28 filling the same to facilitate the breaking of the metal, dirt/refuse as the disc 18 rotates while pushing the same through the open half into the second part of the cylinder.

Additional, in FIG. 1A, the cylinder 12 is seen to include a secondary support 22 extending the length thereof and includes ground-engaging base triangular members 23, 23 positioned at the front and rear of the cylinder 12 with elongated support bars 24, 24 interconnecting the members 23, 23 with spaces triangular units 25, 25 disposed within the support bars 24, 24 to reinforce the same with other parts identified herein below.

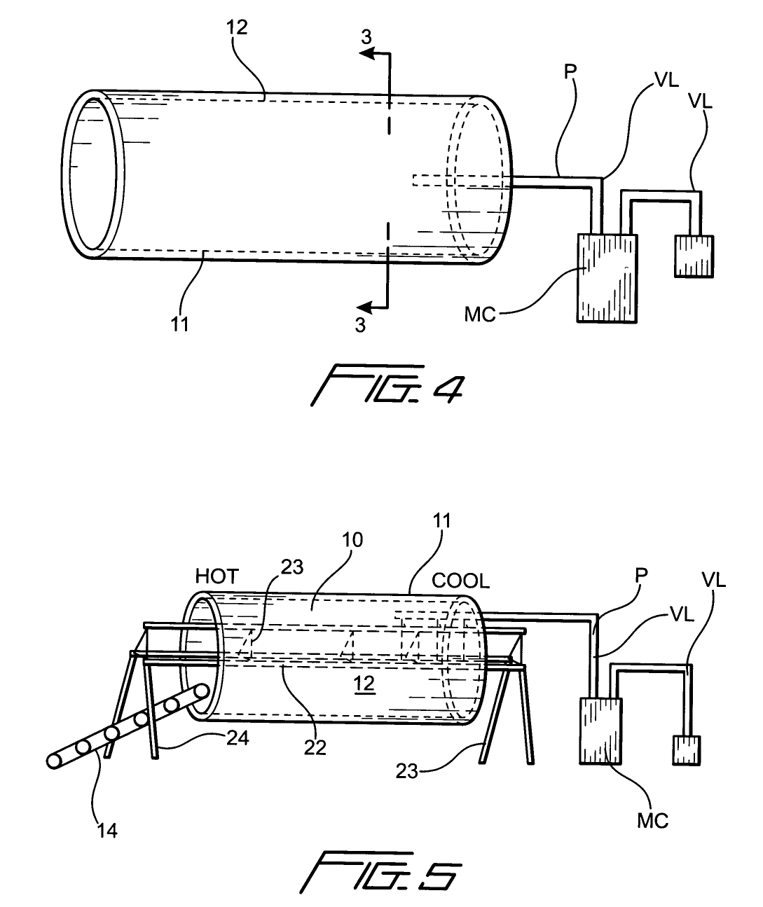

And, as seen in FIG. 3, the secondary support 22 at FIG. 1A shows a cut-out view showing a triangular unit 25 in dotted outline supporting a lower dust collector DC and a scraper SC with vacuum lines VL for conveying the removed metal and dirt/refuse to other collectors. The metal collector MC is disposed outwardly of the confines of the housing 12 (as seen in FIG. 4) to accumulate the separated metal, and whereat the dirt/refuse is discarded.

The inlet and outlet conveyors 14, 15 of FIGS. 1, 1A and 5 are included only to suggest the same and the location of each. Neither is critical to the details shown, the only necessity being that the material be fed into and out of the housing in a normal fashion.

I claim:

1. A method for collecting a mixture of metal and dirt, refuse, etc. and separating the metal from the dirt/refuse by directing the metal for collection and reuse and directing the dirt/refuse for collection and disposal.

2. The method of claim 1 wherein the metal is heated.

3. The method of claim 1 wherein the metal is cooled to solidify the same and thereafter scraped off for collection and reuse.

4. An apparatus for separating a mixture of metal from dirt/refuse including a rotary double-walled cylindrical housing means for collecting a mixture of metal and dirt/refuse therein, a disc separating the housing into at least two sections, one of said sections having heat introduced into said double-walled housing, and the other section having coolant introduced into the other double-walled housing, said disc facilitating the separation of metal from dirt/refuse and causing the metal to solidify on the cooled double-walled housing, and the dirt/refuse to fall to the bottom for disposal, means for scraping the solidified metal from the double-walled housing.

5. The apparatus of claim 4 wherein wheels are disposed on the bottom of said housing for rotating the same.

6. The apparatus of claim 5 wherein inlet and outlet conveyor means are provided at the front and rear of said housing.

7. The apparatus of claim 6 wherein the disc is partially closed and partially opened with the closed portion having breaking means for pulverizing the metal and dirt/refuse.

8. The apparatus of claim 7 wherein the breaking means are chains and tangs.

9. The apparatus of claim 8 wherein spaced triangular means are disposed in the housing for additional support for the same.
